(19) United States
(12) Patent Application Publication
(10) Pub. No.: US 2008/0144899 A1
(43) Pub. Date: Jun. 19, 2008

(54) Process for extracting periodic features from images by template matching

(76) Inventors: Manoj Varma, Tripunithura (IN); Ganapathy Krishnamurthi, West Lafayette, IN (US)

Correspondence Address: BOSE MCKINNEY & EVANS LLP;2700 FIRST INDIANA PLAZA, 135 NORTH PENNSYLVANIA, INDIANAPOLIS, IN, 46204, US

(21) Appl. No.: 11/998,297

(22) Filed: Nov. 29, 2007

Related U.S. Application Data
(60) Provisional application No. 60/867,894, filed on Nov. 30, 2006.

(51) Int. Cl. G06K 9/00

(52) U.S. Cl. 382/129

(57) ABSTRACT

A method for extracting array elements from an image of an array, the array being contained within a well of a substrate is provided. The method comprises detecting coordinate locations of frequency spectrum peaks in the image by establishing local regions of the image, each local region containing a distinct frequency spectrum peak of the image; determining grid spacing and rotational characteristics of the image by analyzing the detected coordinate locations of the frequency spectrum peaks with a Fourier transform analysis; using the grid spacing and rotational characteristics of the image to generate a well template, the well template accounting for each array element's relative location within the well; and cross-correlating the generated well template with the image of the array to determine matched locations, the cross-correlated well template accounting for each array element's actual coordinate location within the well.

### RELATED APPLICATIONS

This application claims priority to U.S. Provisional Patent Application Ser. No. 60/867,894, filed Nov. 30, 2006, the disclosure of which is expressly incorporated herein in its entirety by this reference. This application is also related to U.S. patent application Ser. No. 10/726,772, entitled “Adaptive Interferometric Multi-Analyte High-Speed Biosensor,” filed Dec. 3, 2003 (published on Aug. 26, 2004 as U.S. Pat. Pub. No. 2004/0166593), which is a continuation-in-part of U.S. Pat. No. 6,685,885, filed Dec. 17, 2001 and issued Feb. 3, 2004, the disclosures of which are all incorporated herein by this reference. This application is further related to U.S. patent application Ser. No. 11/345,462 entitled “Method and Apparatus for Phase Contrast Quadrature Interferometric Detection of an Immunoassay,” filed Feb. 1, 2006; and also U.S. patent application Ser. No. 11/345,477 entitled “Multiplexed Biological Analyzer Planar Array Apparatus and Methods,” filed Feb. 1, 2006; and also U.S. patent application Ser. No. 11/345,564, entitled “Laser Scanning Interferometric Surface Metrology,” filed Feb. 1, 2006; and also U.S. patent application Ser. No. 11/345,566, entitled “Differentially Encoded Biological Analyzer Planar Array Apparatus and Methods,” filed Feb. 1, 2006, the disclosures of which are all incorporated herein by this reference.

### TECHNICAL FIELD

The present invention relates generally to biological microarray processing techniques, and more particularly to one or more processes for using templates generated from the image frequency spectrum to extract periodic features from images of biological microarrays.

### BACKGROUND OF THE INVENTION

In many chemical, biological, medical, and diagnostic applications, it is desirable to detect the presence of specific molecular structures in a sample. Many molecular structures such as cells, viruses, bacteria, toxins, peptides, DNA fragments, and antibodies are recognized by particular receptors. Biochemical technologies including gene chips, immunological chips, and DNA arrays for detecting gene expression patterns in cancer cells, exploit the interaction between these molecular structures and the receptors. [For examples, see the descriptions in the following articles: Sanders, G. H. W. and A. Manz, Chip-based microsystems for genomic and proteomic analysis. Trends in Anal. Chem., 2000, Vol. 19(6), p. 364-378. Wang, J., From DNA biosensors to gene chips. Nucl. Acids Res., 2000, Vol. 28(16), p. 3011-3016; Hagman, M., Doing immunology on a chip. Science, 2000, Vol. 290, p. 82-83; Marx, J., DNA Arrays reveal cancer in its many forms. Science, 2000, Vol. 289, p. 1670-1672]. These technologies generally employ a stationary chip prepared to include the desired receptors, i.e., those interacting with the target analyte or molecular structure under test. Since the receptor areas can be quite small, chips may be produced which test for a plurality of analytes. Ideally, many thousand binding receptors are used to provide a complete assay. When the receptors are exposed to a biological sample, only a few may bind a specific protein or pathogen. Ideally, these receptor sites are identified in as short a time as possible.

One such technology for screening for a plurality of molecular structures is the so-called immunological compact disc, which simply includes an antibody microarray. [For examples, see the descriptions in the following articles: Ekins, R., F. Chu, and E. Biggart, Development of microspot multi-analyte ratiometric immunoassay using dual fiourescent-labelled antibodies. Anal. Chim. Acta, 1989, Vol. 227, p. 73-96; Ekins, R. and F. W. Chu, Multianalyte microspot immunoassay—Microanalytical “Compact Disk” of the Future. Clin. Chem., 1991, Vol. 37(11), p. 1955-1967; Ekins, R., Ligand assays: from electrophoresis to miniaturized microarrays. Clin. Chem., 1998, Vol. 44(9), p. 2015-2030]. Conventional fluorescence detection is employed to sense the presence in the microarray of the molecular structures under test. Other approaches to immunological assays employ traditional Mach-Zender interferometers that include waveguides and grating couplers. [For examples, see the descriptions in the following articles: Gao, H., et al., Immunosensing with photo-immobilized immunoreagents on planar optical wave guides. Biosensors and Bioelectronics, 1995, Vol. 10, p. 317-328; Maisenholder, B., et al., A GaAs/AlGaAs-based refractometer platform for integrated optical sensing applications. Sensors and Actuators B, 1997, Vol. 38-39, p. 324-329; Kunz, R. E., Miniature integrated optical modules for chemical and biochemical sensing. Sensors and Actuators B, 1997, Vol. 38-39, p. 13-28; Dubendorfer, J. and R. E. Kunz, Reference pads for miniature integrated optical sensors. Sensors and Actuators B, 1997 Vol. 38-39, p. 116-121; Brecht, A. and G. Gauglitz, recent developments in optical transducers for chemical or biochemical applications. Sensors and Actuators B, 1997, Vol. 38-39, p. 1-7]. While interferometric optical biosensors have the intrinsic advantage of interferometric sensitivity, they are often characterized by large surface areas per element, long interaction lengths and complicated resonance structures. They also can be susceptible to phase drift from thermal and mechanical effects.

The biological compact disc was introduced as a sensitive spinning-disc interferometer that operates at high-speed and is self-referencing [see M. M. Varma, H. D. Inerowicz, F. E. Regnier, and D. D. Nolte, “High-speed label-free detection by spinning-disk micro-interferometry,” Biosensors & Bioelectronics, vol. 19, pp. 1371-1376, 2004 and U.S. Pat. No. 6,685,885, which was previously incorporated by reference above]. These types of optical biosensors are capable of generating images of some optical parameter, such as fluorescence or reflectance. Generally, various test spots are laid out in periodic patterns or arrays on the spinning disc substrate and divided into several radially placed wells. Due to the varying radial positions of the wells, some rotation is typically present in the generated images. As the amount of rotation differs from well to well, and depends on factors such as the centering of the disc, developing standard template-matching methods has proven difficult, particularly as different templates must be generated for each individual well. Moreover, when using spinning disc substrates, the sampling rate and pixel-to-pixel distance between extracted periodic features will also vary with the radius of the disc.

The present invention is intended to address and/or to improve upon one or more of the problems discussed above.

### SUMMARY OF THE INVENTION

The present teachings are generally related to extracting periodic features from images by using templates generated from the image frequency spectrum. After the template is generated, template matching is used to detect array elements within the wells. The frequency domain information used to generate the template is insensitive to background variations and defects.

According to one aspect of the present teachings, a method for extracting array elements from an image of an array, wherein the array is contained within a well of a substrate is provided. The method comprises detecting coordinate locations of frequency spectrum peaks in the image by establishing local regions of the image, wherein each local region contains a distinct frequency spectrum peak of the image. Grid spacing and rotational characteristics of the image are determined by analyzing the detected coordinate locations of the frequency spectrum peaks with a Fourier transform analysis. The grid spacing and rotational characteristics of the image are used to generate a well template, wherein the well template accounts for each array element's relative location within the well. The generated well template is cross-correlated with the image of the array to determine matched locations, wherein the cross-correlated well template accounts for each array element's actual coordinate location within the well.

According to another aspect of the present invention, a method for extracting array elements from an image is provided. The method comprises generating an image of a well, wherein the well contains an array of elements. A pre-filtering operation is performed to remove discontinuities from the image and the coordinate locations of frequency spectrum peaks in the image are detected by establishing local regions of the image, wherein each local region contains a distinct frequency spectrum peak of the image. Grid spacing and rotational characteristics of the image are then determined by analyzing the detected coordinate locations of the frequency spectrum peaks with a Fourier transform analysis, and the grid spacing and rotational characteristics of the image are used to generate a well template, wherein the generated well template accounts for each array element's relative location within the well. The generated well template is then cross-correlated with the image of the array to determine matched locations, wherein the cross-correlated well template accounts for each array element's actual coordinate location within the well. A local cross-correlation operation is then maximized by refining the actual location of the array elements.

According to yet another aspect of the present invention, a method for extracting array elements from an image of an array is provided, wherein the array is contained within a well of a spinning disc substrate. The method comprises performing a pre-filtering operation to remove discontinuities from the image, and detecting coordinate locations of frequency spectrum peaks in the image by establishing local regions of the image. Each established local region contains a distinct frequency spectrum peak of the image and is established by using spot pattern geometric and sampling rate information. Grid spacing and rotational characteristics of the image are determined by analyzing the detected coordinate locations of the frequency spectrum peaks with a Fourier transform analysis, and the grid spacing and rotational characteristics of the image are used to generate a well template, wherein the well template accounts for each array element's relative location within the well. The generated well template is cross-correlated with the image of the array to determine matched locations, and each array element's actual coordinate location is calculated based on the matched locations by shifting a distance of a pixel with a maximum pixel value from a center of a cross-correlation image between the generated well template and the actual coordinate location of each array element. A local cross-correlation operation is then maximized by refining the actual location of each array element.

### BRIEF DESCRIPTION OF THE DRAWINGS

This application contains at least one drawing executed in color. Copies of this patent or patent application publication with color drawing(s) will be provided by the Patent Office upon request and payment of the necessary fee.

The above-mentioned aspects of the present invention and the manner of obtaining them will become more apparent and the invention itself will be better understood by reference to the following description of the embodiments of the invention taken in conjunction with the accompanying drawings, wherein:

FIGS. 1-3 depict images of an array of protein spots printed on a spinning disc substrate in accordance with the present teachings;

FIG. 4 depicts a flow diagram depicting an exemplary process for extracting periodic features from a substrate in accordance with the present invention;

FIG. 5 depicts rotation in the frequency spectrum as determined by the location of the frequency peaks and as related to grid spacing by standard Fourier transform relations in accordance with the present teachings;

FIG. 6 depicts an exemplary 8×8 well template generated using frequency spectrum information in accordance with the present teachings; and

FIG. 7 depicts the extraction of spot pixels for further calculation in accordance with the present teachings.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

As used herein, “disc” or “disk” refers to the carrier of the diagnostic assays and test pattern. “Test pattern” refers to the arrangement of wells on the disc. Finally, as used herein, “well” refers to the area on the disc for holding diagnostic assays and conducting tests. It should also be understood herein that each printed spot (element) or collection of spots on the disc can serve as an assay. Moreover, each spot, element or feature within the molecular arrays of the present teachings may contain a different molecular species, and the molecular species within a given feature may differ from the molecular species within the remaining features of the molecular array.

The biological compact discs of the present invention are sensitive detection platforms that detect immobilized biomolecules on the surface of a spinning disc by using high-speed and self-referencing quadrature laser interferometry. In contrast to static interferometric detection techniques, the present detection platforms are directed to spinning-disc interferometry (SDI™) techniques, which have the advantage of operating faraway from 1/f system noise, and have a 40 dB per octave slope, thereby reducing the detection noise floor by more than 50 dB.

In quadrature interference, the presence of protein causes a phase shift in a signal beam that interferes with a reference beam, which is about [symbol] 2 or 3 [symbol] /2 out of phase. Embodiments using common-path interferometry locally produce signal and reference beams so that they share common optical paths. Moreover, the relative phase difference is locked at about [symbol] /2 and is unaffected by mechanical vibration or motion. By working at quadrature, the total interference intensity shift changes linearly and with maximum slope as a function of the phase shift caused by proteins. Moreover, by working with a high-speed spinning disc, the typical 1/f system noise has a 40 dB per octave slope. Furthermore, at a frequency well above the 1/f noise, a 50 dB noise floor suppression can be obtained, thereby making it possible to measure protein signals with high precision.

Several different quadrature classes have been reported, each of which differ in the way they establish their quadrature condition. One such class is the micro-diffraction class (“MD-class”), which uses gold microstructures that are λ/8 in height to set the phase difference between the light reflected from the gold structure and the substrate. Quadrature is locked using microstructures fabricated on the disc that diffract a focused laser beam to the far field with a fixed relative phase. In one embodiment, gold spokes having a height of λ/8 are deposited by evaporation onto a reflecting surface, and bio-molecules are immobilized on either the gold spokes or the land. Because the phase difference is set by the height difference of the local microstructure, it is unaffected by mechanical motion or vibration. Immobilized bio-molecules change the relative phase, which is converted to amplitude modulation in the far field. For further details of the MD-class, see U.S. patent application Ser. No. 10/726,772 filed Dec. 3, 2003, entitled “Adaptive Interferometric Multi-Analyte High-Speed Biosensor,” which was previously incorporated by reference in its entirety.

Another exemplary quadrature class in accordance with the present teachings is the adaptive-optic quadrature class (“AO-class”), which was introduced using self-adaptive non-linear optical mixing in a photorefractive quantum well to adaptively track the phase difference between signal and reference beams. In one embodiment, patterned protein structures modulate optical phase of the probe beam, which is sent to a photorefractive quantum well (PRQW) device and mixed with a reference local oscillator beam by two-wave mixing. The two-wave mixing self-compensates mechanical disturbances to maintain the quadrature condition with a compensation rate higher than a kHz. Phase modulation caused by protein structures on the spinning disc have frequencies higher than the compensation rate and can be read out by a photodetector. For further details of the AO-class, see U.S. patent application Ser. No. 10/726,772 filed Dec. 3, 2003 entitled “Adaptive Interferometric Multi-Analyte High-Speed Biosensor”, previously incorporated by reference herein in its entirety.

A third exemplary quadrature detection class in accordance with the present teachings is the phase-contrast class (“PC-class”), which is analogous to phase-contrast imaging. It uses a Fourier transform of the light diffracted by a protein edge and uses a spilt detector at the Fourier plane to detect intensity shifts at two opposite quadrature angles. The PC-class of quadrature interferometric detection is discussed in U.S. utility application Ser. No. 11/345,462 filed Feb. 1, 2006 and entitled “Method and Apparatus for Phase Contrast Quadrature Interferometric Detection of an Immunoassay”, previously incorporated herein by reference.

Another quadrature detection class in accordance with the present teachings is the in-line quadrature class, which is based on the quadrature interference of light reflected from the top SiO₂ surface of the biological compact disc substrate and from the bottom silicon surface of the substrate. The phase difference of these two beams is set by the oxide thickness. When the oxide thickness is λ/8 or 3λ/8, the two beams are in quadrature. The presence of protein scatters the incident beam and adds an optical phase shift, which is then converted to a far-field intensity shift. The intensity shift not only depends on the quadrature interference, but also on the surface electric field strength, and the actual protein signal is a combination of these two factors. The in-line class of quadrature interferometric detection is further disclosed in U.S. utility application Ser. No. 11/675,359 filed Feb. 15, 2007 and entitled “In Line Quadrature and Anti-Reflection Enhanced Phase Quadrature Interferometric Detection,” the disclosure of which is incorporated in its entirety by this reference.

Yet another quadrature detection class is the molecular interferometric imaging (MI2) class, which is a common-path interferometric imaging technique for detecting protein binding to surfaces. The experimental metrology limit of this imaging technique is 10 picometer/pixel longitudinal resolution at 0.4 micron diffraction-limited lateral resolution, corresponding to 1.7 attogram of protein, which is only 8 antibody molecules per pixel near to single-molecule detection. The scaling mass sensitivity at the metrology limit is 5 fg/mm. The MI2 class of quadrature interferometric detection is further disclosed in U.S. utility application Ser. No. 11/744,726 filed May 4, 2007 and entitled “Molecular Interferometric Imaging Process and Apparatus,” the disclosure of which is incorporated in its entirety by this reference.

Prior to describing various embodiments of the present invention, the intended meaning of quadrature in the interferometric detection system(s) of the present invention is further explained. In some specific applications quadrature might be narrowly construed as what occurs in an interferometric system when a common optical “mode” is split into at least 2 “scattered” modes that differ in phase by about N* [symbol] /2 (N being an odd integer). However, in other exemplary embodiments, an interferometric system is in quadrature when at least one mode “interacts” with a target molecule and at least one of the other modes does not, where these modes differ in phase by about N* [symbol] /2 (N being an odd integer). This definition of quadrature is also applicable to interferometric systems in which the “other mode(s),” referring to other reference waves or beams, interact with a different molecule. The interferometric system may be considered to be substantially in the quadrature condition if the phase difference is [symbol] /2 (or N* [symbol] /2, wherein N is an odd integer) plus or minus approximately twenty or thirty percent. The phrase “in-phase” is intended to describe in-phase constructive interference, and “out of phase” is intended to describe substantially 180-degree-out-of-phase destructive interference. This is to distinguish these conditions, for both of which the field amplitudes add directly from the condition of being “in phase quadrature” that describes a relative phase of an odd number of π/2.

The spinning disc substrates of the present invention include optical biological compact discs containing immobilized antibodies. One or more samples, each sample potentially containing an antigen, are deposited onto the surface of the biological disc. Once the biological disc has been prepared for analysis, it is introduced to a disc reader, where the disc is analyzed using interferometric and/or fluorescence methods to determine if the antigen is present or absent in the sample.

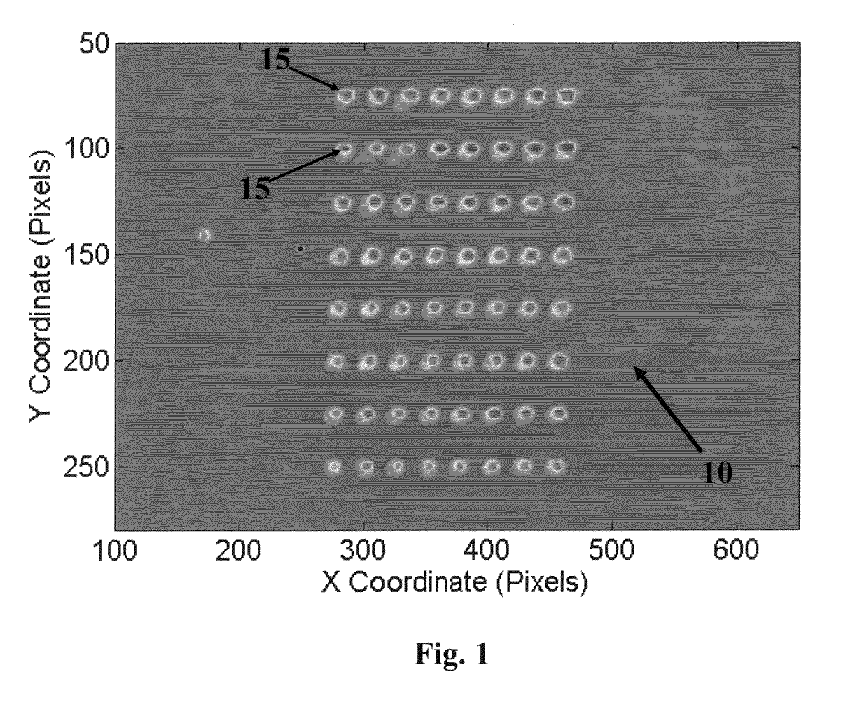

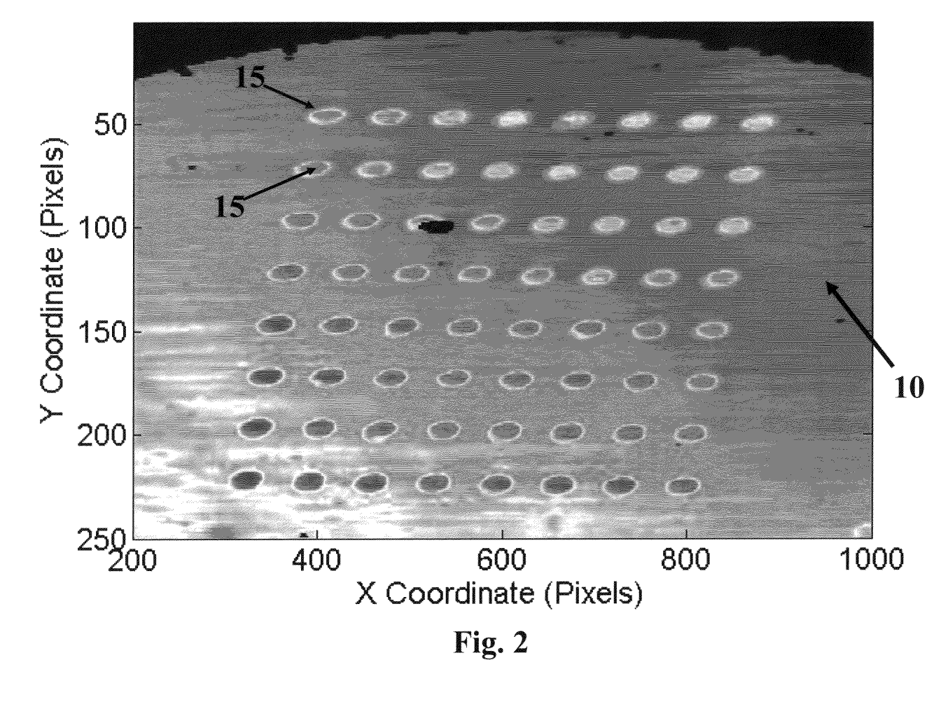

The biological compact discs include a substrate that is adapted to reflect a light beam directed thereon by the disc reader. The disc is structured for spinning disc interferometry and is generally disc-shaped, except for a flat section cut across a chord on one edge of the disc. The flat section is used for positioning of the disc in the disc reader. The substrate includes a base layer of silicon and a layer of silicon dioxide, which has a thickness of approximately between about 80 nm and about 100 nm. At least a portion of the substrate's surface may be printed with hydrophobic material to separate the substrate's surface into individual wells. FIGS. 1 and 2 show an image of an individual well 10, which contains a periodic pattern (i.e., an array) of elements 15 that have been printed therein. Each element 15 comprises biologically immobilized antibodies. In certain embodiments, the elements 15 or spots are protein spots and may be printed in a unit cell pattern, where each unit cell comprises a 2×2 array of spots separated by the substrate surface. According to this exemplary embodiment, each spot is approximately 120 μm in diameter and is separated from neighboring spots by approximately 200 μm. Moreover, the spots along one diagonal of the 2×2 array may be specific to the antigen and the spots along the other diagonal may be configured such that they are not specific to the antigen.

In certain exemplary embodiments herein, the elements 15 are arranged on the surface of the molecular array in rows and columns that together comprise a two-dimensional matrix, or grid. Features in alternative types of molecular arrays may be arranged to cover the surface of the molecular array at higher densities, as, for example, by offsetting the features in adjacent rows to produce a more closely packed arrangement of features.

It should be understood and appreciated herein that the substrate formats of the present invention can be highly varied. For instance, according to certain embodiments, the spots can be directly imaged into the wells 10 of the biological compact disc. In yet other embodiments, a conventional well plate can be used in which the spots are printed onto an optically flat bottom that has been coated with dielectric layers that provide the quadrature condition. Useful substrates in accordance with the present teachings include glass substrates (e.g., AR coatings on glass, dielectric stacks on glass, etc.) and silicon substrates (e.g., 120 nm oxide on silicon, 100 nm oxide on silicon, 80 nm oxide on silicon, SiN on silicon, etc.). It should also be understood and appreciated herein that there are many different disc configurations usable with the present invention. For instance, in certain exemplary embodiments, the periodic test pattern or array on the disc may comprise anywhere from about 10 wells to about 10,000 wells. Moreover, each disc can have different design parameters based on the tests that are being run, e.g., incubation times, well assignments, wash buffers, etc. In other words, the test pattern of the wells on the substrates can vary depending on the desired implementation of the screening procedure to be conducted. As such, various sizes of wells can be developed for different diagnostic applications in accordance with the present invention.

Processes for manufacturing exemplary spinning disc substrates in accordance with the present invention occur via direct printing methods. One such exemplary process for directly printing the wells 10 on the disc involves the use of a Pad Printing Ink Printer machine (XP-13 CE, Pad Print Machinery of VT, Inc., of East Dorset, Vt., USA). According to this process, hydrophobic wells are directly printed onto the disc substrate by printing techniques, such as pad printing techniques or screen printing techniques. Pad printing techniques are particularly useful because these techniques have effective performance standards, particularly in terms of their dimensional pattern specifications and the printing sharpness of the well edges. Moreover, the inks needed to create the desired surface energies and thickness of the wells is much more widely available for such pad printing techniques. While numerous different inks may be used to print the wells in accordance with the present teachings, one such exemplary printing ink is the PLT4G ink available from Pad Print Machinery of VT, Inc. of East Dorset Vt., USA. Other than the pigment itself, 2-methoxy-1-methylethyl and butylglycol acetates (solvents) are the main components of the ink. Since the ink is in itself a mixture, minor changes in composition are unlikely to result in a major change in properties. Additional information regarding the printing of wells on the discs of the present invention is further disclosed in U.S. utility application Ser. No. 11/743,913 filed May 3, 2007 and entitled “Direct Printing of Patterned Hydrophobic Wells”, which is incorporated in its entirety herein by this reference.

Once the wells have been created on the disc's substrate, a sample potentially containing an antigen is introduced into one or more wells of the substrate. When the disc is exposed to the sample, the antigen in the sample will bind selectively to the specific antibodies and increase the surface mass of the spots with those specific antibodies more than the surface mass of spots with non-specific antibodies. The sample may undergo one or more incubation, washing and drying steps before being analyzed by the disc reader. Interferometrically, the changes in mass are seen as height changes of the spots.

After preparation of the disc, it is analyzed by a disc reader. The disc reader spins the substrate like a traditional compact disc and directs a laser beam of a specific wavelength onto the surface of the disc. The return signal from the surface of the disc is directed to a detector located on the same side of the substrate as the laser source. The disc reader interrogates the disc using either interferometric or fluorescence techniques, or both. According to certain exemplary embodiments, the laser used in the disc reader has a wavelength of 532 nm, and the light path from the laser source to the disc to the detector includes at least one planar optical element.

In interferometric interrogation, the beam is reflected by the substrate and the spots of the unit cells that have been exposed to the sample. The disc reader is designed to accurately determine mass variations of the spots in the unit cells based on the quadrature interference of light reflected from the surface of the disc. The mass variations of samples on the disc are detected interferometrically by converting surface phase modulation into amplitude modulation as the disc is spun beneath the laser beam. By identifying which locations gained height and which did not, and by measuring the change in height, the target analytes in the sample can be identified and quantified.

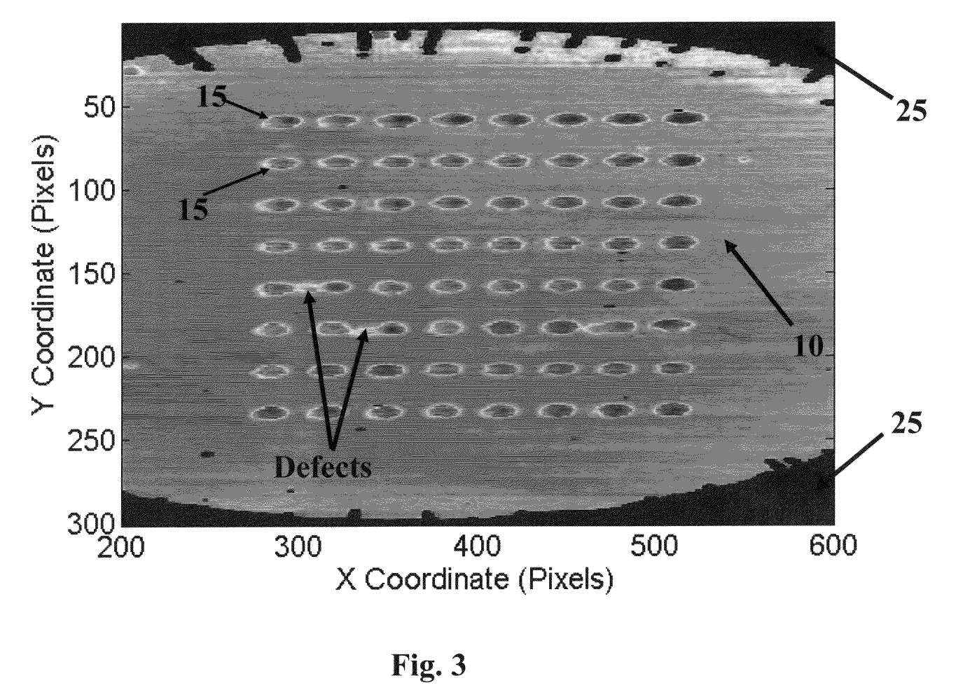

Due to the varying radial position of the wells on the substrate, there is always rotation present in the generated images of the arrays. As explained above, the amount of rotation present in the images differs from well to well and depends on factors such as the centering of the disc, which makes a priori determination of these quantities for each well impossible. Therefore, standard methods of feature extraction using template matching are difficult to achieve, particularly as different templates must be generated for each individual well. Moreover, when using spinning substrates, the sampling rate and pixel-to-pixel distance between periodic feature elements varies with the radius of the disc (for instance, compare the pixel-to-pixel distance between the periodic feature elements of FIGS. 1 and 2). As such, intensity based segmentation methods do not work well for template matching, particularly in light of background variations (see FIG. 2) and the potential presence of defects in the array, which could masquerade as spots during the analysis of the substrate (see for instance, FIG. 3, which shows defects in the array). The present method, however, improves upon these problems by generating a template for each well by using information in the frequency domain, and then doing template matching to detect the elements of the array. Furthermore, the frequency domain information used to generate the templates is insensitive to variations in background and defects.

Merely by way of example, the present invention focuses primarily on array images containing protein spots. It should be recognized and appreciated herein, however, that the methods of the invention are useful for the analysis of images from any type of readout signal generated from arrays of any class of molecules, cells or tissues. Moreover, the following information presents a detailed description of the invention and its application to spotted array image analysis. This description is by way of an exemplary illustration of the general method of this invention. This example is non-limiting, and related variants will be apparent to one of skill in the art.

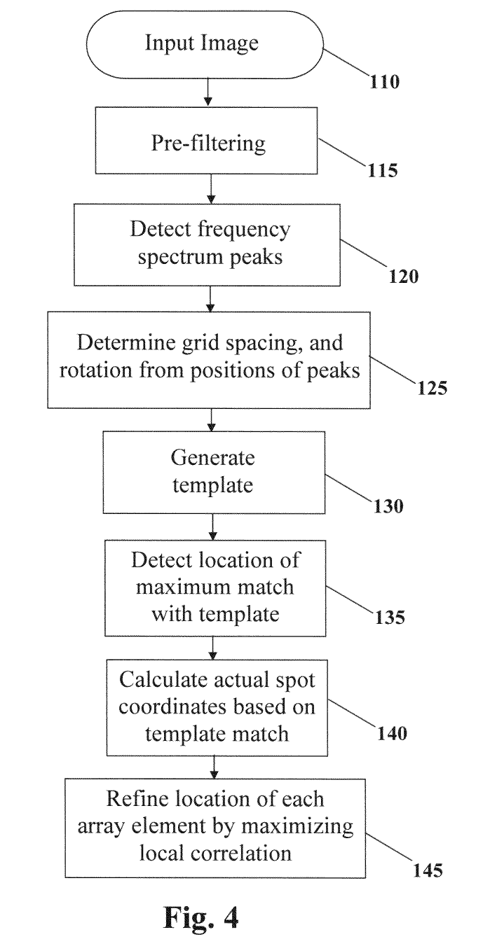

The principles upon which exemplary embodiments of the present teachings rely can be understood with reference to FIG. 4, which illustrates a flow diagram depicting a process for extracting periodic features from a substrate. The first steps involve inputting the image 110 and then pre-filtering 115 the inputted image. More particularly, the raw image is read and basic filtering operations (such as low pass filtering) are done as needed. Any image detection device capable of generating a readout signal from arrays and having separate spatial channels to detect light at multiple locations on the image plane would be useful in accordance with the present invention. Such image detection devices include, but are not limited to, charge-coupled device (CCD) detectors, complementary metal oxide semiconductor (“CMOS”) image sensors, pixel array devices and instruments sensitive to radioactivity, light, temperature, ions and/or electrical signals.

After the image is inputted 110, the pre-filtering operation 115 is performed to remove discontinuities or any localized features from the image, and to ensure that image noise and clutter do not interfere with the spot detection process. The pre-filtering step 115 includes removing the padded region 25, which is the structure that surrounds the substrate wells and defines the region to which the array elements 15 are held for reacting with the biological sample undergoing analysis (see FIG. 3). To excise the pad 25 from the image, it is detected by selecting all pixels whose values are below the mean value of the well and setting the pixel values to the average of the lower 25% of the well pixels. Removing and conditioning the pad 25 in this manner ensures that there are no discontinuities in the image, which would interfere with the detection of the frequency domain peaks.

After the pad 25 is excised, any high-intensity streaks within the image are removed as part of the pre-filtering operation 115. High-intensity streaks can be caused by various chemical processing steps, including debris and leeched protein material. Similar to removing the pad 25, the high-intensity streaks are removed to ensure that no discontinuities are present in the image. To remove the high-intensity streaks from the image, a threshold is chosen based on the pixel values of the streaks relative to the well background. For example, the top 0.1% of the pixels may correspond to areas containing high-intensity peaks, in which case, the threshold is the 99.9^{th} percentile value of the pixel distribution. In according to this exemplary embodiment, all pixels whose values are above this threshold are set to the average of the well image.

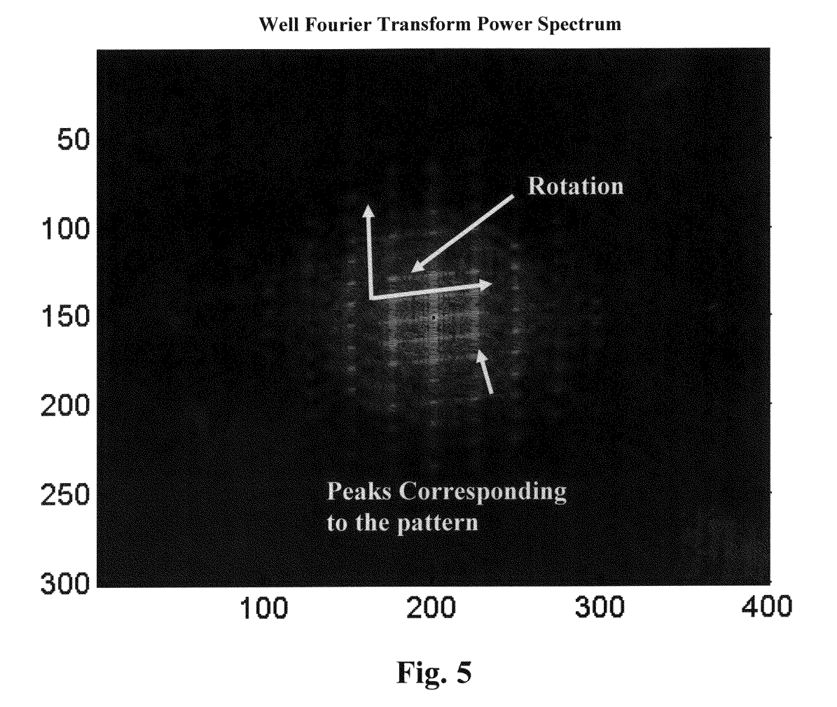

After the pre-filtering step 115 is performed, the frequency spectrum peaks in the image are detected (step 120). An illustration of an exemplary frequency spectrum, along with the peaks that are to be determined, is shown in FIG. 5. To determine the coordinate locations of the frequency spectrum peaks in accordance with the present invention, any standard peak-finding algorithm or spectral analysis method, such as a frequency/time-frequency domain methods, parametric and eigenanalysis methods, harmonic analyses and two-signal analyses can be used. Those skilled in the art will readily appreciate that other such peak-finding algorithms or spectral analysis methods may also be used to locate the locations of frequency spectrum peaks, whereby the present invention is not intended to be limited herein. In certain exemplary embodiments, Fourier transform analysis methods are used to determine the coordinate locations of the frequency spectrum peak. In other embodiments, existing information (i.e., a priori information) about the geometry of the spot pattern and the sampling rate of the image acquisition system is used to establish local neighborhoods or regions containing distinct frequency peaks of the well image. In specific embodiments, four (4) local neighborhood regions, each containing a distinct frequency peak of the well image, are used. In accordance with these embodiments, this information is used to find the maximum value in each local neighborhood, whose location provides required periodicity information. Unlike traditional template matching processes, which use frequency domain information as a filter to enhance periodic features and remove background noise, the present invention uses frequency domain peak locations to explicitly construct a template including calculated spatial periodicity and grid rotation information. Moreover, these traditional processes calculate the grid parameters from the filtered image, while the present invention directly estimates them from the power spectrum thereby avoiding an additional filtering step.

After detecting coordinate locations of the frequency spectrum peaks, grid spacing and rotational characteristics are determined (step 125). The position of the frequency peaks is related to the grid spacing by standard Fourier transform relations analysis, and the rotation in the frequency spectrum can be determined by the peak locations. As the rotation in the image is the same as the rotation of its frequency spectrum, this relationship enables the determination of the rotation in the grid. In accordance with this step, assume Gxᵢ and Gyᵢ (i=1 to 4) to be the distance of the Fourier power spectrum peak from the center of the power spectrum image in each of the four quadrants. The corresponding spacing in the real image is given by α/<Gx> and α/<Gy>, where α is the conversion from frequency domain to spatial domain dimensions and the <Gx> & <Gy> are the average estimates of Gxᵢ and Gyᵢ based on any two of the four peaks. The rotation angle of the grid is given by arctan((Gy₁−Gy₄)/(Gx₁−Gx₄)) and arctan((Gy₁−Gy₂)/(Gx₁−Gx₂)). These two angles describe small angle rotations and shears (both row and column shears) to the pattern caused by the data acquisition process.

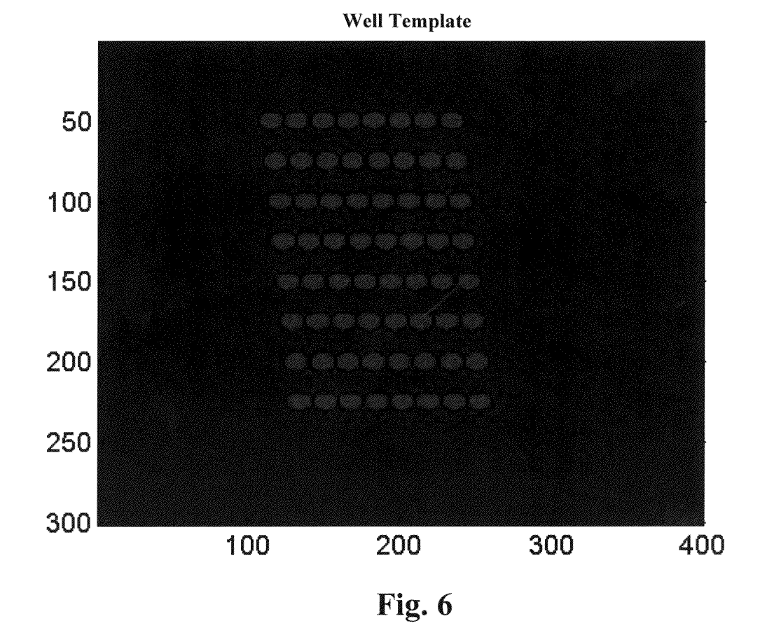

The next step in the exemplary process for extracting periodic features from a substrate involves the generation of a binary template (step 130). According to this step, the grid spacing and rotation information found in the previous step (step 125) is used to construct a unique template for each well. More particularly, the positions of all the spots in the template are set and recorded, and the background pixels of the template set to zero. The region corresponding to the array element or protein spots defined by a circle of fixed radius centered on each spot position are filled with ones (1's). While the generated template can also have any shape and/or size depending on the number of elements contained within the well, an exemplary 8×8 grid is shown in FIG. 6. According to this exemplary embodiment, the well template has a grid pattern, which accommodates 64 array elements; the 64 array elements being arranged in 8 columns and 8 rows).

The next step involves the determination of the maximum match with the template (step 135). More particularly, as the template represents the relative positions of the elements of the grid, it does not contain the actual/absolute locations of the elements in the well. As such, to determine the actual locations of the elements, the template must be cross-correlated with the original image. To achieve this, the distance of the pixel with the maximum pixel value from the center of the cross-correlation image represents the shift between the generated template and the actual spot locations. The actual locations of the spots in the image are then obtained by adding the shift obtained in step 135 to the spot locations recorded when generating the template (step 140).

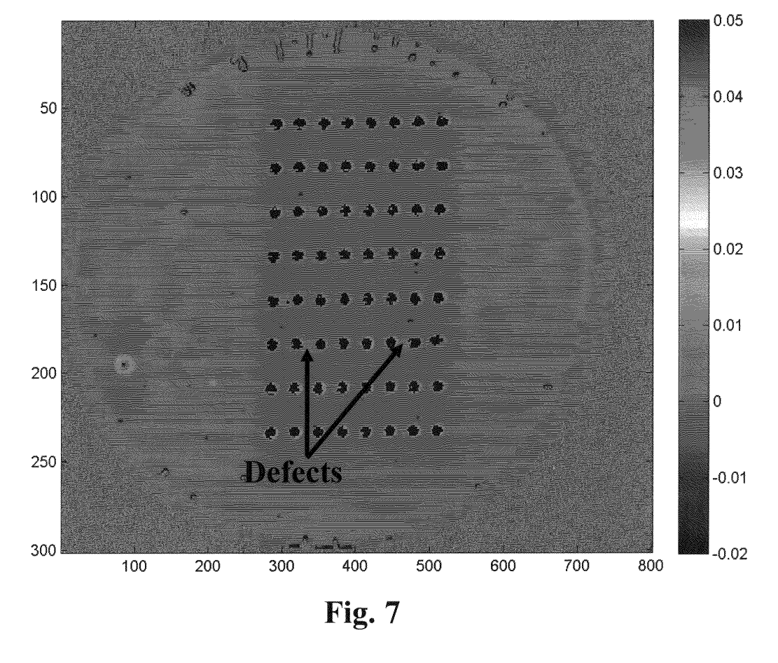

Finally, a refinement step is performed, in which the location of each array element is refined by maximizing the local correlation (step 145). More particularly, from the locations determined in the previous step (step 140), a rectangular region centered on the spot location with dimensions ⅓ of the spot spacing is selected for each array element and a local cross-correlation operation is performed with an array element template. The cross-correlation is the same as described in the template matching process. More particularly, the array element template or spot template is the binary image of a spot, the size of the image being the same as the rectangular region chosen from the well image. As described previously, the distance of the maximum of the cross-correlation field from the center of the cross-correlation image is used to shift the previously recorded spot positions, which accounts for deviations of the printed spot locations from the grid positions. At this stage, the coordinates of the array elements are well determined and the pixels can be extracted from each spot for further calculation (see FIG. 7). For instance, rectangular regions centered on the adjusted spot positions with dimensions equal to ½ the spot spacing can be chosen, and median of the top 2% of the pixels in the rectangular region is then the spot signal.

There are several advantages of this method over conventional correlation methods. For instance, the template matching process can be performed globally rather than locally. Therefore, this method is robust to local defects in the grid, such as missing or badly smeared spots. Other methods are susceptible to errors caused by local defects. Moreover, there is only a single global constraint imposed in the first template-matching step followed by a refinement step. This is less computationally intensive than doing local template matching and imposing a multitude of additional constraints on the local matches thus obtained. Intensity based segmentation, without imposing global constraints, is prone to error in cases where defects masquerade spots. The present method also does not use morphological information explicitly or require any scanning modifications. Furthermore, unlike local search methods, which have difficulty defining robust threshold values for the features of interest, the present method is insensitive to variations in background intensity. The present method also allows rotation to be estimated directly from the frequency spectrum without any parametric search or statistical learning (unlike computationally intensive iterative procedures). Moreover, incorporating control features on the substrate to facilitate feature extraction is not necessary, as well as no manual interaction is required with the present process.

It should also be understood and appreciated herein that the present teachings are not limited to spinning disc substrates. More particularly, those skilled in the art will understand that the present processes may also extend to microarray images produced by scanning (rather than spinning) a substrate, and particularly where there are misalignments between the printing arm and the substrate. Moreover, the present teachings may also be used with any image where it is necessary to determine coordinate locations of periodic features, such as DNA microarrays based on fluorescence, atomic force microscopy (“AFM”), and the like. As such, the present invention is not intended to be limited herein.

While an exemplary embodiment incorporating the principles of the present invention has been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCES

The following references are incorporated herein by reference in their entirety:
1. IEEE TRANSACTIONS ON MEDICAL IMAGING, VOL. 22, NO. 7, JULY 2003 “Intensity-Based Segmentation of Microarray Images”
2. “Fourier Analysis and Imaging”, R. N. Bracewell, Kluwer Academic/Plenum Publishers, c2003
3. Sanders, G. H. W. and A. Manz, Chip-based microsystems for genomic and proteomic analysis. Trends in Anal. Chem., 2000, Vol. 19(6), p. 364-378
4. Wang, J., From DNA biosensors to gene chips. Nucl. Acids Res., 2000, Vol. 28(16), p. 3011-3016
5. Hagman, M., Doing immunology on a chip. Science, 2000, Vol. 290, p. 82-83
6. Marx, J., DNA Arrays reveal cancer in its many forms. Science, 2000, Vol. 289, p. 1670-1672
7. Ekins, R., F. Chu, and E. Biggart, Development of microspot multi-analyte ratiometric immunoassay using dual fluorescent-labelled antibodies. Anal. Chim. Acta, 1989, Vol. 227, p. 73-96
8. Ekins, R. and F. W. Chu, Multianalyte microspot immunoassay—Microanalytical “compact Disk” of the future. Clin. Chem., 1991, Vol. 37(11), p. 1955-1967
9. Ekins, R., Ligand assays: from electrophoresis to miniaturized microarrays. Clin. Chem., 1998, Vol. 44(9), p. 2015-2030
10. Gao, H., et al., Immunosensing with photo-immobilized immunoreagents on planar optical wave guides. Biosensors and Bioelectronics, 1995, Vol. 10, p. 317 328
11. Maisenholder, B., et al., A GaAs/AlGaAs-based refractometer platform for integrated optical sensing applications. Sensors and Actuators B, 1997, Vol. 38-39, p. 324-329
12. Kunz, R. E., Miniature integrated optical modules for chemical and biochemical sensing. Sensors and Actuators B, 1997, Vol. 38-39, p. 13-28
13. Dübendorfer, J. and R. E. Kunz, Reference pads for miniature integrated optical sensors. Sensors and Actuators B, 1997 Vol. 38-39, p. 116-121
14. Brecht, A. and G. Gauglitz, recent developments in optical transducers for chemical or biochemical applications. Sensors and Actuators B, 1997, Vol. 38-39, p. 1-7
15. M. M. Varma, H. D. Inerowicz, F. E. Regnier, and D. D. Nolte, “High-speed label-free detection by spinning-disk micro-interferometry,” Biosensors & Bioelectronics, vol. 19, pp. 1371-1376, 2004

What is claimed is:

1. A method for extracting array elements from an image of an array, the array being contained within a well of a substrate, comprising:
detecting coordinate locations of frequency spectrum peaks in the image by establishing local regions of the image, each local region containing a distinct frequency spectrum peak of the image;
determining grid spacing and rotational characteristics of the image by analyzing the detected coordinate locations of the frequency spectrum peaks with a Fourier transform analysis;
using the grid spacing and rotational characteristics of the image to generate a well template, the well template accounting for each array element's relative location within the well; and
cross-correlating the generated well template with the image of the array to determine matched locations, the cross-correlated well template accounting for each array element's actual coordinate location within the well.

2. The method of claim 1, further comprising performing a pre-filtering operation to remove discontinuities from the image.

3. The method of claim 2, wherein performing a pre-filtering operation to remove discontinuities from the image comprises excising a pad from the image by selecting well pixels in the image having a value below a mean value of the well and further setting the well pixel values to equal an average of a lower 25% of the well pixels.

4. The method of claim 2, wherein performing a pre-filtering operation to remove discontinuities from the image comprises removing high-intensity streaks from the image.

5. The method of claim 1, wherein the substrate comprises a spinning disc substrate.

6. The method of claim 1, wherein the image is selected from at least one of a protein microarray image and a DNA microarray image.

7. The method of claim 1, further comprising maximizing a local cross-correlation operation by refining the actual location of each array element.

8. The method of claim 1, wherein the image is generated by an image detection device that is selected from at least one of a charge-coupled device detector, a complementary metal oxide semiconductor image sensor, a pixel array device and an atomic force microscopy device.

9. The method of claim 1, wherein the coordinate locations of the frequency spectrum peaks are detected by a peak-finding algorithm.

10. The method of claim 9, wherein the peak-finding algorithm includes a Fourier transform analysis.

11. The method of claim 1, wherein the local regions of the image are established using spot pattern geometric and sampling rate information, the information being used to find a maximum value in each local region to calculate grid parameters of the image from the locations of frequency spectrum peaks.

12. The method of claim 1, wherein using the grid spacing and rotational characteristics to generate a well template comprises setting and recording the relative position for each array element.

13. The method of claim 1, wherein cross-correlating the generated well template with the image of the array comprises shifting a distance of a pixel with a maximum pixel value from a center of a cross-correlation image between the generated well template and the actual coordinate location of each array element.

14. A method for extracting array elements from an image, comprising:
generating an image of a well, the well containing an array of elements;
performing a pre-filtering operation to remove discontinuities from the image;
detecting coordinate locations of frequency spectrum peaks in the image by establishing local regions of the image, each local region containing a distinct frequency spectrum peak of the image;
determining grid spacing and rotational characteristics of the image by analyzing the detected coordinate locations of the frequency spectrum peaks with a Fourier transform analysis;
using the grid spacing and rotational characteristics of the image to generate a well template, the well template accounting for each array element's relative location within the well;
cross-correlating the generated well template with the image of the array to determine matched locations, the cross-correlated well template accounting for each array element's actual coordinate location within the well; and
maximizing a local cross-correlation operation by refining the actual location of each array element.

15. The method of claim 14, wherein the image is selected from at least one of a protein microarray image and a DNA microarray image.

16. The method of claim 14, wherein the image is generated by an image detection device that is selected from at least one of a charge-coupled device detector, a complementary metal oxide semiconductor image sensor, a pixel array device and an atomic force microscopy device.

17. The method of claim 14, wherein the coordinate locations of the frequency spectrum peaks are detected by a Fourier transform analysis.

18. A method for extracting array elements from an image of an array, the array being contained within a well of a spinning disc substrate, comprising:
performing a pre-filtering operation to remove discontinuities from the image;
detecting coordinate locations of frequency spectrum peaks in the image by establishing local regions of the image, each local region containing a distinct frequency spectrum peak of the image and being established by using spot pattern geometric and sampling rate information;
determining grid spacing and rotational characteristics of the image by analyzing the detected coordinate locations of the frequency spectrum peaks with a Fourier transform analysis;
using the grid spacing and rotational characteristics of the image to generate a well template, the well template accounting for each array element's relative location within the well;
cross-correlating the generated well template with the image of the array to determine matched locations;
calculating each array element's actual coordinate location based on the matched locations by shifting a distance of a pixel with a maximum pixel value from a center of a cross-correlation image between the generated well template and the actual coordinate location of each array element; and
maximizing a local cross-correlation operation by refining the actual location of each array element.

19. The method of claim 18, wherein using the grid spacing and rotational characteristics to generate a well template comprises setting and recording the relative position for each array element.

20. The method of claim 18, wherein the image is generated by an image detection device that is selected from at least one of a charge-coupled device detector, a complementary metal oxide semiconductor image sensor, a pixel array device and an atomic force microscopy device.
